(19) United States
(12) Patent Application Publication
(10) Pub. No.: US 2005/0083937 A1
(43) Pub. Date: Apr. 21, 2005

(54) IP address lookup method using pipeline binary tree, hardware architecture, and recording medium

(76) Inventor: Hyesook Lim, Seoul (KR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/963,810

(22) Filed: Oct. 14, 2004

(30) Foreign Application Priority Data
Oct. 15, 2003 (KR) 2003-71928

(51) Int. Cl. H04L 12/56

(52) U.S. Cl. 370/392; 370/408

(57) ABSTRACT

The present invention relates to an IP address lookup method, a hardware architecture, and a recording medium. The present invention relates to an IP address lookup method searching the longest matched prefix by constructing a binary tree having enclosure prefixes as root nodes, extracting sub-trees of enclosures as individual trees from a maintree in the binary tree, and comparing an input address with prefixes included in nodes of the maintree and nodes of the sub-trees by using a pipelining scheme, a hardware architecture, and a recording medium. According to the present invention, it is possible to efficiently utilize a memory by using the best advantage of a binary prefix tree structure in that there is no empty node in the tree and the fact that a binary search process can be implemented by using pipelines. In addition, it is possible to provide a practical, excellent architecture capable of performing an address lookup procedure by using at most one content addressable memory access and one memory access.

### BACKGROUND OF THE INVENTION

1. Field of the Invention

The present invention relates to an IP address lookup method, a hardware architecture, and a recording medium, and more particularly, to an IP address lookup method searching an input address by constructing a binary tree having enclosure prefixes as root nodes, extracting sub-trees of enclosures as individual trees from a maintree in the binary tree, and comparing a prefix of an input address with prefixes included in nodes of the maintree and nodes of the sub-trees by using a pipelining scheme, a hardware architecture, and a recording medium.

2. Description of the Related Art

One of the most challenging tasks that should be performed in the Internet routers widely used in the world is to accurately forward a received packet to its destination. In order to implement the task, every router comprises a forwarding table. Information on next hop addresses and output ports used to access the destination are obtained by using the forwarding table. When the packet is received, the router performs a process for referring to the forwarding table by using the Network Part of the destination IP addresses of the received packet as a key. This is called an address lookup process. The Network Part used for the address lookup procedure is called a prefix.

Conventionally, there is a classful addressing scheme for the IP address lookup process. In the scheme, the lengths of the prefixes of the IP address are fixed in 8, 16, or 24 bits. Since the lengths of the prefixes are fixed, the classful addressing scheme has a problem in that some of the IP addresses are wasted. In addition, the scheme has another problem in that, as the kinds of the networks are increasing, the size of the forwarding table has to exponentially increase.

In order to solve the problems of the classful addressing scheme, there is proposed a classless inter-domain routing (CIDR) scheme. In the CIDR scheme, since the lengths of the prefixes are not fixed, it is possible to prevent the IP addresses from wasting. In addition, since IP addresses can be aggregated, it is possible to prevent the size of the forwarding table from rapidly increasing. However, the CIDR scheme has a problem in that the so-called longest prefix matching process has to be performed. Since an incoming packet does not carry information on the prefix length of its own final network, a process has to be performed to search an entry having the longest prefix among the entries of the forwarding table having prefixes matched with the prefix of the address of the incoming packet. In other words, various address lookup processes conventionally used for the exact matching cannot be adapted to the longest prefix matching scheme.

On the other hand, the link speed for the Internet router is expected to increase up to 10 Gbps or more. In addition, in order to process various types of prefixes, the forwarding table of the backbone router and table search algorithm is expected to have a large number of entries, for example, hundreds of thousand entries. In the aforementioned Internet environment, the address lookup procedure using the longest prefix matching scheme becomes a main factor of determining performance of the router. Therefore, efficient IP address lookup algorithms and architectures have been widely and actively researched.

The address lookup procedure is classified into several approaches based on its access scheme.

A first approach is an address lookup procedure using a Trie structure. FIG. 1 is a view showing an example of the Trie structure representing multiple prefixes. The Trie structure is a tree-based structure where a relationship between prefixes is represented to be easy to know. The Trie structure is the most representative one. In the Trie structure, every prefix is located at a single node in the tree, which defines a path from a root node. Many researches have been made on architectures of storing the Trie structure in a memory and the associated IP address lookup schemes. However, the approach has a problem in that the memory is wasted since prefix-unassigned internal nodes are stored. In addition, there is a problem in that W times of memory accesses are performed assuming that W is the height of the tree.

A second approach is an IP address lookup procedure using a binary search process combined with a hashing process applied to prefixes of the same length. The hashing process has been popularly used for Layer-2 address lookup which requires exact matching. However, the binary search combined hashing scheme has a problem in that a pure binary search process cannot be applied thereto. In other words, even in a case where the entry searched by the hashing does not include a prefix, a large number of best matching prefixes of the entry and markers indicating that a longer prefix exists have to be stored due to the longest prefix matching characteristics of the IP address. Therefore, there is a problem in that overhead is induced to calculate the large number of the best matching prefixes and markers in advance. In addition, since it is based on an assumption that a perfect hash function can be rapidly obtained with respect to a given prefix distribution, the binary search combined hashing scheme is not practical.

As a third approach, a parallel search procedure using hashing has been proposed in order to solve the problems. In the parallel search procedure using hashing, all the prefix lengths are subject to a parallel search using individual hashing function corresponding to the prefix lengths, and then, the longest matched prefix is retrieved among the matched prefixes. In the parallel search procedure using hashing, a perfect hash function is not assumed and a hash function constructed with exclusive-OR logics is used. The parallel search procedure using hashing is a very practical structure used to solve collisions associated with the hashing process by using a sub-table. However, in a case where the collisions occur in a main table, the binary search process is performed with the sub-table, so that the maximum memory access times may greatly increase. In addition, in order to solve the collisions in hashing, multiple hashing tables are proposed to store new prefixes in entries where a small number of collisions occur. However, any hardware architecture implementing the associated data structure has not been proposed.

On the other hand, the aforementioned address lookup procedures using hashing have a problem originated from the hashing structure. That is, a memory waste problem associated with empty entries is not solved.

A fourth approach is an IP address lookup procedure using a ternary content addressable memory (TCAM). This approach has been used for an actual switch or router. The input IP address is directly compared with all the prefixes stored in the TCAM, so that the speed of the IP address lookup procedure is very high. However, there is a problem in that the technique associated with the TCAM has not coped with the rapidly increasing number of prefixes used for the router. In other words, in comparison with a SRAM having the same memory size, the TCAM stores a very small number of prefixes. In addition, the cost of the TCAM is too high. Therefore, it is difficult to implement the TCAM for storing several ten-thousands of prefixes. In addition, it is difficult to embed the TCAM in a chip designed for the IP address lookup. Therefore, it is difficult to apply the technique associated with the TCAM to the forwarding tables of a backbone router having several ten-thousands of entries and the IPv6 having addresses of 128-bit length.

A fifth approach is an IP address lookup procedure applying a binary search process to prefixes having different lengths. Like the hashing process, the binary search process can be adapted to Layer-2 address lookup. In this approach, sizes of the two prefixes having different lengths are defined and, when a prefix includes another prefix, enclosure is defined. By using definitions, the IP address lookup procedure can be implemented with the binary search process. Since all the nodes in the tree structure are allocated with prefixes, this approach has an advantage in that the prefixes can be efficiently stored without the memory waste. However, since the tree structure is not balanced, this approach has a disadvantage in that it is difficult to implement the tree structure in a hardware manner.

Now, the IP address lookup procedure using a conventional tree structure to apply the binary search process to the prefixes having different lengths will be described in detail. Hereinafter, the data structure is called a binary prefix tree (BPT) in order to be distinguished from the Trie structure of prefixes. A process of constructing the BPT starts with a process of sorting prefixes having different lengths. To sort prefixes with different lengths, BPT defines the followings.

Definition 1 (Comparison): Assume there are two prefixes A=a₁a₂ . . . aₙ and B=b₁b₂ . . . bₘ.
1. If n=m, the numerical values of A and B are compared.
2. If n!=m (assuming n<m), the two substrings A=a₁a₂ . . . aₙ and B=b₁b₂ . . . bₙ are compared. The prefix with bigger (smaller) numeric value is defined to be bigger (smaller) If the two substrings A=a₁a₂ . . . aₙ and B=b₁b₂ . . . bₙ are equal to each other, then the (n+1)-th bit of string B is compared. If b₍ₙ₊₁₎ is 1, B>A. Otherwise, B<A.

Definition 2 (match): Two prefixes A=a₁a₂ . . . aₙ and B=b₁b₂ . . . bₘ match if n=m and two strings are identical, or (assuming n<m) two substrings a₁a₂ . . . aₙ and b₁b₂ . . . bₙ are the same. Otherwise, A and B do not match.

Definition 3 (disjoint): Two prefixes A and B are called disjoint if none of them is a prefix of another.

Definition 4 (enclosure): A prefix A is called an enclosure if there is at least one prefix having the prefix A as a prefix.

Now, the process of constructing the binary prefix tree will be described.

Firstly, all the prefixes are sorted based on the values thereof according to Definition 1 to generate a list. Next, all the prefixes are compared to each other. If some prefixes are enclosures of other prefixes (Definition 4), the enclosure prefixes are included in enclosure set. As a result, disjoint prefixes are remained (Definition 3). The disjoint prefixes are sorted based on the values thereof. Algorithm 1 shows a detailed process of sorting the prefixes based on the values thereof.

[Algorithm 1]

Sort Procedure
/*List contains all initial and sorted prefixes. */
Sort(List)
/*First find enclosures */
for all i in List do;

compare i with all j in List where j!= i;
if i matches j then

if i is shorter than j, then /*i is

enclosure of j*/

put j in i's bag.
delete j from List.

else

put i in j's bag.
delete i from List.

end compare;

end for;
/*Now sort them */
for all i in List do;

compare i with all j in List where j!= i;
if j<i, then

exchange i with j.

end compare;

end for;
end Sort;

Algorithm 1 has the worst case performance of O(N²).

Algorithm 2 is a process of constructing the binary prefix tree by using the list generated in Algorithm 1. According to Algorithm 1, the generated list is a binary tree recursively divided by half. It should be noted that, if the prefix at the dividing point is the enclosure according to Definition 4, all the prefixes of the enclosure are included in a sub-tree having the enclosure as a root node. In addition, it should be noted that a prefix indicate not a point but a specific range of which starting point is the prefix. In the binary search process, since higher nodes are searched prior to lower nodes, the enclosures are put into the higher nodes in order to search the enclosures first.

[Algorithm 2]

Building Tree Procedure
BuildTree(List)

if List is empty, return.
Sort(List)
let m be the median of List
root <= m;
let leftList and rightList contain all

elements in the left and right of m.

if m is an enclosure, then,

distribute elements in m's bag into

leftList and rightList.

leftChild(root) <= BuildTree(leftList);
rightChild(root) <= BuildTree(rightList);
return address of root.

end BuildTree;

Algorithm 2 has a performance of O(N²log₂N).

Table 1 shows examples of the prefixes.

TABLE 1

| Prefix | Fwd RAM Ptr |
|---|---|
| 10 | 1 |
| 01 | 2 |
| 110 | 3 |
| 1011 | 4 |
| 0001 | 5 |
| 01011 | 6 |
| 00010 | 7 |
| 001100 | 8 |
| 1011001 | 1 |
| 1011010 | 2 |
| 0100110 | 3 |
| 01001100 | 4 |
| 10110011 | 5 |
| 10110001 | 6 |
| 01011001 | 7 |
| 001011 | 8 |
| 00111010 | 1 |
| 1101110010 | 2 |
| 10001101 | 3 |
| 11101101 | 4 |
| 01010110 | 5 |
| 00100101 | 6 |
| 100110100 | 7 |
| 101011011 | 8 |
| 11101110 | 1 |
| 10110111 | 2 |
| 011010 | 3 |
| 011011 | 4 |
| 011101 | 5 |
| 0110010 | 6 |
| 101101000 | 7 |
| 101101110 | 8 |
| 00011101 | 1 |
| 011110110 | 2 |

FIG. 2 shows a binary prefix tree structure where the prefixes of Table 1 are sorted.

It can be understood from FIG. 2 that the sub-trees having the enclosure prefixes 10* as root nodes include all the prefixes having “10*” as a prefix. In FIG. 2, black and white dots denotes the enclosure and disjoint prefixes, respectively. As shown in FIG. 2, the binary tree including 34 prefixes is a unbalanced tree having a height of 10.

[Algorithm 3]

Search Procedure
/*tree points to the root and addr is an IP

address.*/

Search(tree, addr)

if tree=NIL, return NULL;
if (addr<tree(root):,

prefix <= Search(leftChild(tree),

addr);

else

prefix <= Search(rightChild(tree),

addr).

if addr matches tree(root and prefix is

NULL,

prefix <= tree(Node)

return prefix;

end Search;

In Algorithm 3, only in the case where there are no matched prefixes at the lower node, the prefixes at the higher nodes are searched by recursively calling the search procedure. Therefore, a matched prefix at the lowest nodes is selected as the longest prefix. In a hardware design, the matched prefixes at the higher nodes are replaced with the matched prefixes at the low nodes. Since the enclosures are put into the higher nodes, a matched prefix at the lower node means that the matched prefix is longer than the enclosure. Therefore, if the enclosure is replaced with the matched prefix at the lower node, the longest prefix matching with the IP address can be implemented.

On the other hand, a process of updating the binary prefix tree will be described in two cases. Algorithm 4 shows the process of updating the binary prefix tree.

[Algorithm 4]

Insertion Procedure
/*tree points to the root and addr is an IP

address.*/

Insertion(tree, addr)

if tree=NIL, then,

node <= AllocateNode( );
node <= prefix;
make tree parent of node
return;

if prefix is enclosure of tree(root)

then;

replace tree(root with prefix;
insertion(tree, tree(root));
if prefix < tree(root), then;

Move(leftChild(tree),

prefix);

else

Move(rightChild(tree),

prefix);

return;

if prefix < tree(root), then;

Insertion(leftChild(tree), prefix).

else

Insertion(rightChild(tree),

prefix).

end Insertion;

If a to-be-inserted prefix is a disjoint prefix according to Definition 3, the to-be-inserted prefix can be inserted into a leaf of the tree. Therefore, Algorithm 4 has the same performance as the aforementioned address lookup procedure. On the other hand, if the to-be-inserted prefix is an enclosure of other prefixes existing in the binary prefix tree, there is a problem in that the existing prefixes must be replaced with the to-be-inserted prefix and a sub-tree having the newly inserted prefix as a root node must be constructed.

### SUMMARY OF THE INVENTION

In order to solve the aforementioned problems, an object of a first aspect of the present invention is to provide an IP address lookup method searching an input address by constructing a binary tree having enclosure prefixes as root nodes, extracting sub-trees of enclosures as individual trees from a maintree in the binary tree, and comparing an input address with prefixes included in nodes of the maintree and nodes of the sub-trees by using a pipelining scheme, a hardware architecture, and a recording medium.

According to a first aspect of the present invention, there is provided an IP address lookup method using at least one pipeline binary tree having enclosure prefixes as root nodes, comprising steps of: (a) comparing an input address with the enclosure prefixes; (b) as a result of the step (a), if the enclosure prefixes matching with the input address are retrieved, temporarily storing a forwarding RAM pointer of a longest matched enclosure prefix, wherein the longest matched enclosure prefix is an enclosure prefix longest matching with the input address in terms of bits among the matched enclosure prefixes; (c) comparing the input address with prefixes of a sub-tree having the longest matched enclosure prefix as a root node; (d) as a result of the step (c), if there are the prefixes of the sub-tree newly matching with the input address, outputting forwarding RAM pointers of the newly matched prefixes of the sub-tree; (e) as a result of the step (c), if the prefixes of the sub-tree newly matching with the input address are not retrieved, outputting the forwarding RAM pointer temporarily stored in the step (b); (f) as a result of the step (a), if the enclosure prefixes matching with the input address are not retrieved, comparing maintree prefixes with the input address; (g) as a result of the step (f), if the maintree prefixes matching with the input address are retrieved, outputting forwarding RAM pointers of the matched maintree prefixes; and (h) as a result of the step (f), if the maintree prefixes matching with the input address are not retrieved, outputting a default forwarding RAM pointer.

According to a second aspect of the present invention, there is provided an IP address lookup method using at least one pipeline binary tree having only first-level enclosure prefixes as root nodes, comprising steps of: (a) comparing an input address with the enclosure prefixes; (b) as a result of the step (a), if the enclosure prefixes matching with the input address are retrieved, temporarily storing forwarding RAM pointers of the matched enclosure prefixes; (c) comparing prefixes of a sub-tree having the enclosure prefixes as root nodes with the input address;
(d) as a result of the step (c), if there are the prefixes of the sub-tree newly matching with the input address and the newly matched prefixes of the sub-tree have sub-tree pointers, repeatedly comparing the sub-tree prefixes indicated by the sub-tree pointers with the input address until a sub-tree prefix not having the sub-tree pointers is searched; (e) as a result of the step (d), if there are the prefixes of the sub-tree newly matching with the input address and the newly matched prefixes of the sub-tree do not have sub-tree pointers or if the prefixes of the sub-tree newly matching with the input address are not retrieved, outputting a forwarding RAM pointer of a sub-tree prefix last retrieved in the step (d); (f) as a result of the step (c) if the prefixes of the sub-tree newly matching with the input address are not retrieved, outputting the forwarding RAM pointers temporarily stored in the step (b); (g) as a result of the step (a), if the enclosure prefixes matching with the input address are not retrieved, comparing maintree prefixes with the prefix of the address; (h) as a result of the step (g), if the maintree prefixes matching with the input address are retrieved, outputting forwarding RAM pointers of the matched maintree prefixes; and (h) as a result of the step (f), if the maintree prefixes matching with the input address are not retrieved, outputting a default forwarding RAM pointer.

According to a third aspect of the present invention, there is provided an IP address lookup hardware architecture using at least one pipeline binary tree having enclosure prefixes as root nodes, comprising: a content addressable memory (CAM) storing enclosures (root nodes); a memory storing nodes other than the root nodes; and a processing unit for constructing a maintree and a sub-tree by treating the enclosure prefixes as root nodes and performing an address lookup procedure by comparing an input address with prefixes included in the nodes of the maintree and the sub-tree.

According to a fourth aspect of the present invention, there is provided a computer-readable recording medium recording a program used for a system for generating a pipeline binary tree for IP address lookup, wherein the program implementing the functions of: (a) searching enclosure prefixes in a prefix list for IP address lookup; (b) generating a maintree list by removing the enclosure prefixes from the prefix list and generating an enclosure prefix set including the enclosure prefixes; (c) generating sub-tree lists corresponding to the enclosure prefixes included in the enclosure prefix set; (d) sorting prefixes included in the maintree list and the sub-tree lists in accordance with values of the prefixes; (e) generating a maintree and sub-trees having the prefixes included in the maintree list and the sub-tree lists as entries, respectively; and (f) inserting, removing, and updating entries to the pipeline binary tree.

According to a fifth aspect of the present invention, there is provided a method of inserting entries to a pipeline binary tree used for an IP address lookup procedure, comprising steps of: (a) determining whether or not there is a prefix matching with a to-be-inserted prefix; (b) as a result of the step (a), if a matched prefix is retrieved, determining whether or not the to-be-inserted prefix is an enclosure of other enclosure prefixes; (c) as a result of the step (b), if the to-be-inserted prefix is an enclosure of other enclosure prefixes, inserting the to-be-inserted prefix and the forwarding RAM pointer of the to-be-inserted prefix to an enclosure set; (d) as a result of the step (b), if the to-be-inserted prefix is not an enclosure of the other enclosure prefixes, determining whether or not the to-be-inserted prefix is an enclosure of other prefix; (e) as a result of the step (d), if the to-be-inserted prefix is an enclosure of other prefix, constructing a sub-tree of the to-be-inserted prefix with only the retrieved prefix, removing the entry of the retrieved prefix, and inserting the to-be-inserted prefix to the enclosure set; (f) as a result of the step (d), if the to-be-inserted prefix is not an enclosure of the retrieved prefix, inserting the retrieved prefix to the enclosure set, removing the retrieved prefix from a tree where the retrieved prefix was included, and constructing a sub-tree of the retrieved prefix with the to-be-inserted prefix; and (g) as a result of the step (a), if a matched prefix is not retrieved, inserting the to-be-inserted prefix as a new leaf node to the main tree.

### BRIEF DESCRIPTION OF THE DRAWINGS

The above and other features and advantages of the present invention will become more apparent by describing in detail exemplary embodiments thereof with reference to the attached drawings in which:

FIG. 1 is a view showing an example of a Trie structure representing multiple prefixes;

FIG. 2 shows a binary prefix tree structure where the prefixes of Table 1 are sorted;

FIG. 3 is a view showing an example of a pipelined architecture according to the preferred embodiment of the present invention;

FIG. 4 is a view showing a hardware architecture implementing an EnBiT according to a first preferred embodiment of the present invention;

FIG. 5 is a flowchart showing the IP address lookup procedure according to the first preferred embodiment of the present invention;

FIG. 6 is a flowchart showing a process of inserting entries to the EnBiT structure according to the first preferred embodiment of the present invention;

FIG. 7 is a view showing the hardware architecture implementing the EnBiT according to the second preferred embodiment of the present invention;

FIG. 8 is a flowchart showing the IP address lookup procedure according to the second preferred embodiment of the present invention;

FIG. 9 is a view showing a hardware architecture implementing an EnBiT according to a third preferred embodiment of the present invention;

FIG. 10 is a flowchart showing the IP address lookup procedure according to the third preferred embodiment of the present invention; and

FIG. 11 is a flowchart showing a process of inserting prefixes to the EnBiT structure according to the third preferred embodiment of the present invention.

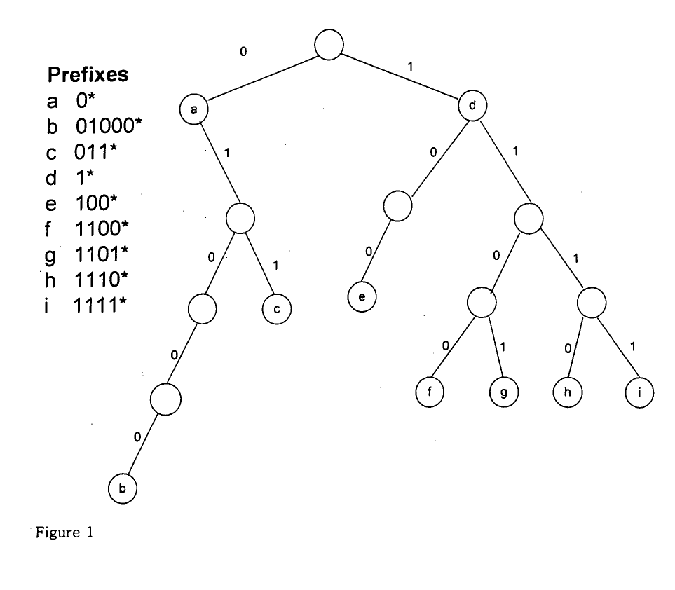

### DETAILED DESCRIPTION OF THE INVENTION

The present invention and operational advantages thereof can be fully understood by referring to the accompanying drawings and explanations thereof. Now, exemplary embodiments of the present invention will be described with reference to the accompanying drawings to explain the present invention in detail. In the drawings, the same reference numerals indicate the same elements. In addition, description of well-known constructions or functions confusing the subject matter of the present invention may be omitted.

The preferred embodiment of the present invention proposes an enhanced binary tree (hereinafter, referred to as “EnBiT”) obtained by modifying a conventional binary prefix tree structure in order to solve the aforementioned problems.

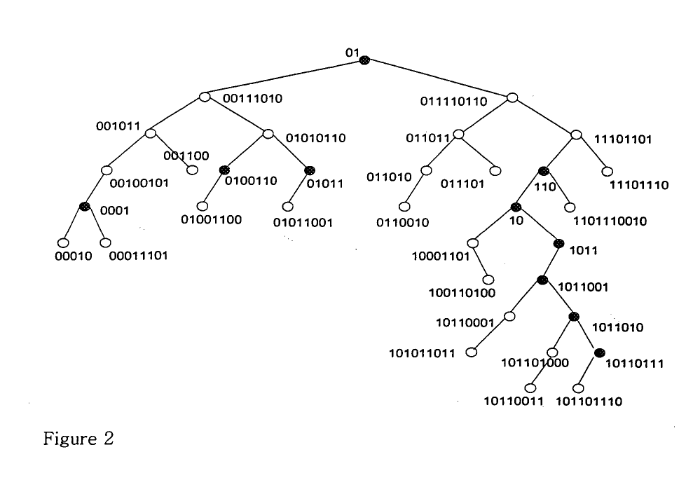

In the conventional binary prefix tree, prefixes which are enclosures of a specific prefix must be included in a sub-tree having the enclosure as a root node. Even though a specific enclosure prefix matches with an input destination IP address, the IP address lookup procedure further proceeds in order to retrieve the longest matched prefix. Due to this restriction, an unbalanced tree is formed as shown in FIG. 2. In addition, it is difficult to implement the unbalanced tree in a hardware manner.

In the EnBiT according to the present invention, attention is paid to the fact that a balanced tree is constructed with disjoint prefixes in order to solve the unbalance of the binary prefix tree. For this reason, in the EnBiT according to the present invention, the sub-trees of the enclosures are extracted as individual trees from the maintree. As a result, the maintree is constructed with only the disjoint prefixes. In addition, all the enclosures includes sub-trees having the enclosures as root nodes and prefixes of all the sub-trees are disjoint to each other.

Algorithm 5 shows a modified sort procedure used for the EnBiT according to the preferred embodiment of the present invention.

[Algorithm 5]

Sort Procedure
/*List contains all initial and sorted
prefixes. */
Sort(List)
/*First find enclosures */
for all i in List do;

compare i with all j in List where j!= i;
if i matches j then

if i is shorter than j, then /*i is

enclosure of j*/

put j in i's bag.
delete j from List.

else

put i in j's bag.
delete i from List.

end compare;

end for;
/* Remove enclosure from List and Sort bag */
for all i in List do

if i's bag is empty, return
add i to enclosure set
Sort (i's bag);
delete i from List;

end for
/*Now sort them */
for all i in List do;

compare i with all j in List where j!= i;
if j<i, then

exchange i with j.

end compare;

end for;
end Sort;

Algorithm 5 is an algorithm for recursively arraying a maintree and sub-trees of all the enclosures. As a result of the array, a maintree list and multiple sub-tree lists belonging to an enclosure set are generated.

Algorithm 6 is a modified algorithm for generating a tree in an EnBiT according to the preferred embodiment of the present invention.

[Algorithm 6]

Building Tree Procedure
BuildTree(List)

if List is empty, return.
Sort(List)
let m be the median of List
root <= m;
let leftList and rightList contain all

elements in the left and right of m.

leftChild(root) <= BuildTree(leftList);
rightChild(root) <= BuildTree(rightList);
return address of root.

end BuildTree;

Algorithm 6 should be recursively performed on the maintree and all the enclosure lists belong to the enclosure set.

In the preferred embodiment of the present invention, provided is a hardware architecture based on a pipelining scheme using the nature of binary search as well as the best advantage of the BPT structure in which an empty node does not need to be stored.

Firstly, the pipelined architecture will be described with reference to an exemplary BPT shown in FIG. 2. The pipelined architecture utilizes the nature of the binary search as it is. Namely, in pipelined architecture, trees are divided based on their depths, and nodes included in each depth are stored in each memory. The memory access can be pipelined based on the depths. Each memory entry stores pointers to its children.

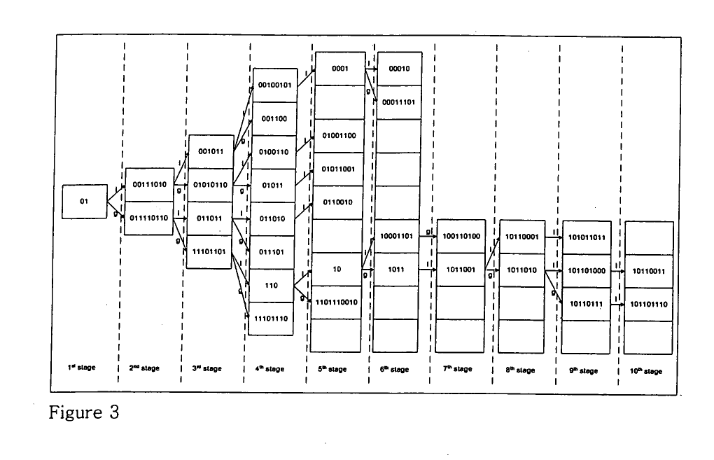

FIG. 3 is a view showing an example of a pipelined architecture according to the preferred embodiment of the present invention.

The tree shown in FIG. 3 is formed by applying the pipelined architecture to the tree shown in FIG. 2. In a case where an address of an input packet is smaller than stored prefixes, the corresponding search proceeds to lower pipeline stages along with the paths pointed with pointer 1. In a case where an address of an input packet is bigger than stored prefixes, the corresponding search proceeds to lower pipeline stages along with the paths pointed with pointer g. Since the BPT is unbalanced, the number of pipeline stages is not determined in advance. As shown in FIG. 3, since pipeline stages are excessively required, it is difficult to implement the pipelined architecture in hardware.

(First Preferred Embodiment)

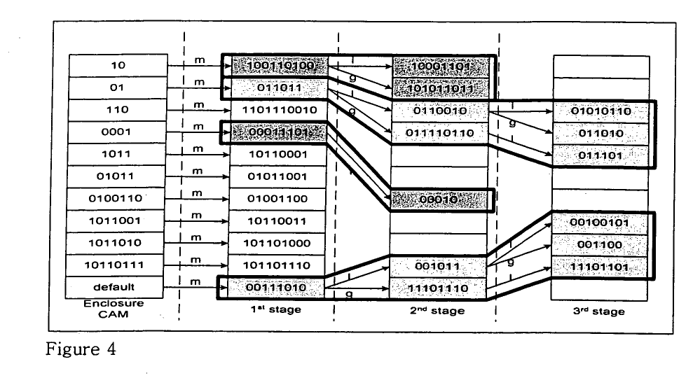

FIG. 4 is a view showing a hardware architecture implementing an EnBiT according to a first preferred embodiment of the present invention.

The hardware architecture shown in FIG. 4 is based on the prefixes shown in the aforementioned Table 1. [ [symbol] ] An address lookup procedure in the EnBiT starts with search for an enclosure having longest match out of enclosures. In FIG. 4, a tree is indicated with a solid line. The tree at the bottom of FIG. 4 is a maintree. In FIG. 4, a pointer m points a case where a prefix of a tree entry matches with the input address. In addition, a pointer 1 points a case where a prefix of a tree entry is smaller than the input address. In addition, a pointer g points a case where a prefix of a tree entry is bigger than the input address. The address lookup procedure using this hardware architecture will be described later.

As shown in FIG. 4, in the first preferred embodiment of the present invention, all the enclosure prefixes are treated as root nodes, and all the root nodes are stored in a CAM. Each entry of the root nodes stores prefix information, a forwarding RAM pointer, and pointers to its sub-trees. On the other hand, each entry of nodes rather than the root nodes stores prefix information, a forwarding RAM pointer, and pointers to its children. As shown in FIG. 4, since nodes of each depth are stored in a separated memory corresponding to the depth, the memory access can be pipelined based on the depths. It can be understood in a simulation result described later that more than 60% of prefixes belong to the maintree and all the trees in the EnBiT are balanced. Therefore, the number of pipeline stages is determined based on the height of the maintree. As shown in FIG. 4, a pipelined architecture having three stages of memory access can be implemented with 34 prefixes of Table 1.

In the pipelined architecture according to the first preferred embodiment of the present invention, all the nodes of each depth are stored in a corresponding single memory, it is possible to perform memory access at all the depths simultaneously. Therefore, in the hardware architecture, address lookup procedure for a series of destination IP addresses can be completed with one memory access.

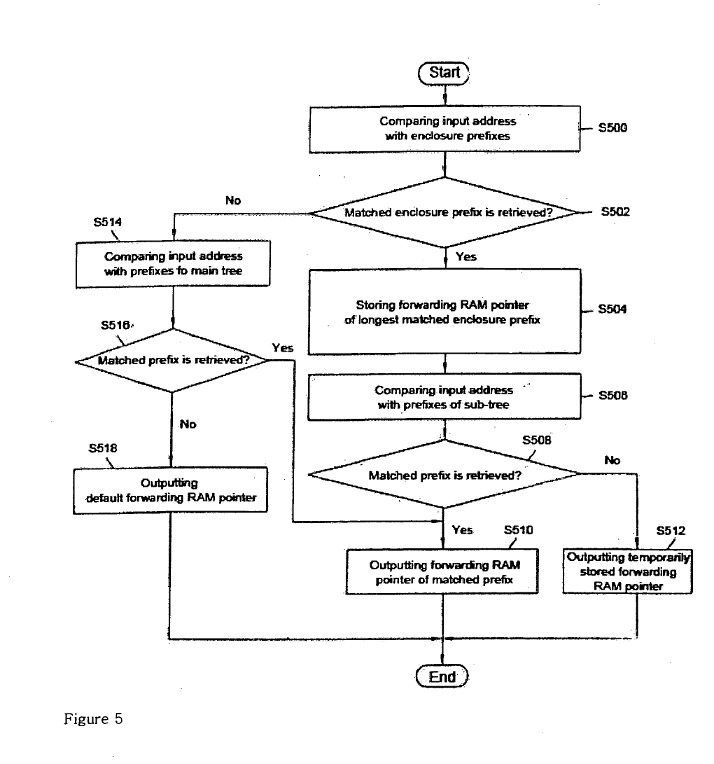

FIG. 5 is a flowchart showing the IP address lookup procedure according to the first preferred embodiment of the present invention.

The address lookup procedure starts with searching enclosure prefixes having the longest match with the input address. As a result, since a tree on which a binary search process is performed is determined in advance, it is possible to efficiently perform the binary search process with smaller search area.

Firstly, the input address is compared with the enclosure prefixes of an enclosure set (S500). As a result, it is determined whether or not the enclosure prefixes matching with the input address are retrieved (S502). If the matched enclosure prefixes are retrieved, a forwarding RAM pointer of the longest matched enclosure prefix, that is, an enclosure prefix longest matching with the input address in terms of bits among the matched enclosure prefixes is temporarily stored (S504). Next, an address lookup procedure using binary search proceeds to a sub-tree which has the longest matched enclosure prefix as a root node (S506). It is determined whether or not there is a prefix of the sub-tree newly matching with the input address (S508). If there is the prefix of the sub-tree newly matching with the input address, the forwarding RAM pointer of the newly matched prefix of the sub-tree is output instead of the temporarily stored forwarding RAM pointer (S510). If there is not prefix of the sub-tree newly matching with the input address during the binary search process on the entire sub-tree, the temporarily stored forwarding RAM pointer is output (S512).

If the enclosure prefix matching with the input address is not retrieved as a result of the step S502, the binary search process is performed on the maintree which is constructed with only disjoint prefixes (S514). It is determined whether or not there is prefix of the maintree matching with the input address (S516). If there is a prefix of the maintree matching with the input address, the forwarding RAM pointer of the matched prefix of the maintree is output (S510). In this case, the address lookup procedure early ends. This is because all the prefixes in the EnBiT according to the first preferred embodiment of the present invention are disjoint. Therefore, if it matches with one prefix, the input address does not match with the others. If the input address does not match with all the prefixes of the maintree, a default forwarding RAM pointer is output (S518).

According to the EnBiT structure of the first preferred embodiment of the present invention, it is easy to merge entries and to update prefixes. In a case where a specific prefix intends to be removed from the EnBiT structure, the to-be-removed specific prefix is retrieved by performing the address lookup procedure, and then the forwarding RAM pointer of the to-be-removed specific prefix is represented to be invalid. Therefore, in an address table updated in this manner, an invalid entry may occur, but not affect the address lookup procedure. In addition, in the address lookup procedure, the prefix value of the invalid entry is used for the aforementioned comparison process, but the corresponding forwarding RAM pointer is not stored.

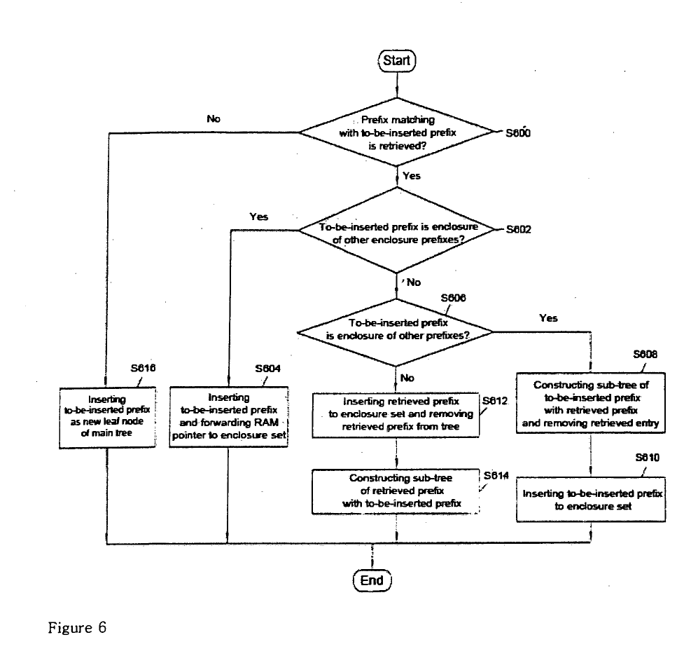

FIG. 6 is a flowchart showing a process of inserting entries to the EnBiT structure according to the first preferred embodiment of the present invention.

As described above, in a case where a new enclosure prefix intends to be inserted to the aforementioned BPT, it is difficult to update the tree. However, according to the first preferred embodiment of the present invention, it is easy to insert the new prefix to the tree. The process of inserting the new prefix is divided into several cases based on the properties of the to-be-inserted-prefixes.

Firstly, it is determined whether or not there is a prefix matches with the to-be-inserted prefix as a result of the address lookup procedure (S600). If the matched prefix is retrieved, it is determined whether or not the to-be-inserted prefix is an enclosure of other enclosure prefixes (602). As a result of the step S602, if the to-be-inserted prefix is an enclosure of other enclosure prefixes, the to-be-inserted prefix and the forwarding RAM pointer thereof are inserted to the corresponding enclosure set (S604). Since an object of the address lookup procedure in the EnBiT according to the first preferred embodiment of the present invention is to retrieve the longest matched prefix among the enclosure prefixes, if the input address matches with only the newly inserted prefix, there is no enclosure prefix having longer match than the newly inserted prefix. Therefore, the forwarding RAM pointer of the newly inserted prefix is output. On the other hand, if the prefix of the input address matches with an enclosure prefix having longer match than the newly inserted prefix, the address lookup procedure proceeds to a sub-tree of the longer matched enclosure prefix.

As a result of the step S602, if the to-be-inserted prefix is not an enclosure of other enclosure prefixes, it is determined whether or not the to-be-inserted prefix is an enclosure of other prefix (602). As a result of the step S606, if the to-be-inserted prefix is an enclosure of other prefix, a sub-tree of the to-be-inserted prefix is constructed with only the retrieved prefix. Next, the retrieved prefix is removed with the aforementioned scheme (S608). This is because all the prefixes of the sub-tree are disjoint. Next, the to-be-inserted prefix is inserted to the corresponding enclosure set (S610). As a result of the step S606, if the to-be-inserted prefix is not an enclosure of other prefix, the retrieved prefix is inserted to the corresponding enclosure set and removed from the tree where the retrieved prefix was included (612). Next, the to-be-inserted prefix is inserted to the sub-tree of the retrieved prefix (S614).

As a result of the step S600, if the matched prefix is not retrieved, that is, if the to-be-inserted prefix is disjoint to all the prefixes, the to-be-inserted prefix is inserted as a new leaf node of the maintree (S616).

As described above, th EnBiT according to the first preferred embodiment of the present invention is a data structure where is constructed with multiple balanced trees having a low height, so that the EnBiT has excellent performance in search and update.

As shown in FIG. 4, in the first preferred embodiment of the present invention, all the enclosure prefixes are treated as root nodes and all the root nodes are stored in the CAM. However, assuming that the number of the prefixes is 100,000 or more and the number of the enclosure prefixes are 7% of the number of the prefixes, there is needed a CAM having about 7,000 entries, so that a chip may be heavily burdened with the CAM. To solve the problem, a hardware architecture implementing an EnBiT according to a second preferred embodiment of the present invention can be used.

(Second Embodiment)

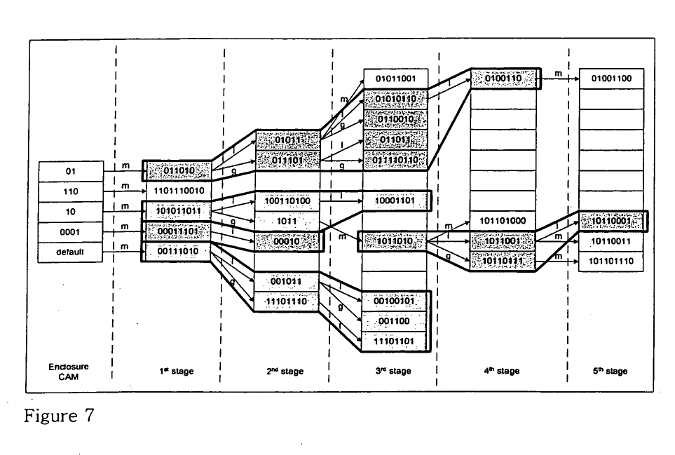

FIG. 7 is a view showing the hardware architecture implementing the EnBiT according to the second preferred embodiment of the present invention. In particular, the hardware architecture shown in FIG. 7 is based on the prefixes shown in the aforementioned Table 1.

In the second preferred embodiment of the present invention, only the enclosures generated in the first stage are stored in the CAM and enclosures existing in sub-tree of an enclosure as well as forming another sub-tree are not stored in the CAM. The sub-trees of such an enclosure can be included in the memory pipelining. Referring to FIG. 7, the pointers m indicate that there are new sub-trees.

In the tree structure shown in FIG. 7, there are sub-trees having a maximum of 3 levels: a first level starting with enclosure 10*; a second level starting with enclosure 1011*; and a third level starting with enclosure 1011010*, enclosure 1011001* or enclosure 10110111*.

In comparison of FIGS. 4 and 7, the maintrees are the same. The sub-tree of the enclosure 10* is constructed with a different number of prefixes, that is, 3 and 4 prefixes in FIGS. 4 and 7, respectively. In addition, in FIG. 7, a new sub-tree starts at the first level enclosures.

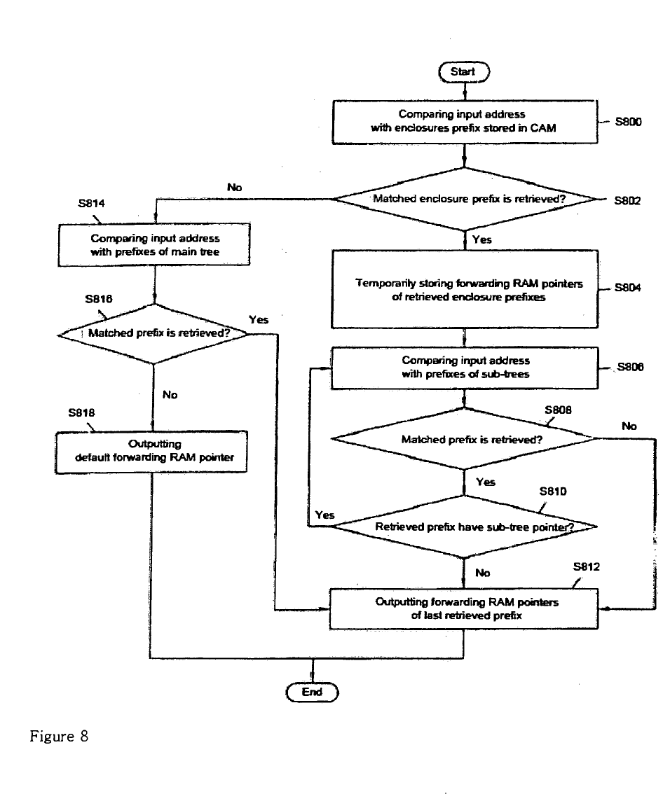

FIG. 8 is a flowchart showing the IP address lookup procedure according to the second preferred embodiment of the present invention.

Firstly, the input address is compared with the enclosure prefixes stored in the CAM (S800). As a result, it is determined whether or not the enclosure prefix matching with the input address is retrieved (S802). If the matched enclosure prefix is retrieved, a forwarding RAM pointer of the matched enclosure prefix is temporarily stored (S804). Next, an address lookup procedure using binary search proceeds to a sub-tree which has the matched enclosure prefix as root node (S806). It is determined whether or not there is a prefix of the sub-tree newly matching with the input address (S808). If there is the prefix of the sub-tree newly matching with the input address, it is determined whether or not the matched prefix has a pointer indicating other new sub-tree (810). As a result of the step S810, if the matched prefix has a pointer indicating other new sub-tree, the address lookup procedure proceeds to the new sub-tree. The address lookup procedure continues until a disjoint node is retrieved. In other words, if there is not the prefix of the sub-tree newly matching with the input address, or if the newly matched prefix is retrieved and the retrieved prefix does not have sub-tree pointer, the forwarding RAM pointer of the last retrieved prefix is output. As a result of the step S806, if there is no newly matched prefix in the sub-tree having the retrieved enclosure prefix as root node, the forwarding RAM pointer temporarily stored in the step S804 are output.

If the enclosure prefix matching with the input address is not retrieved as a result of the step S502, the binary search process is performed on the maintree which are constructed with only disjoint prefixes (S814). It is determined whether or not there is a prefix of the maintree matching with the input address (S816). If there is the prefix of the maintree matching with the input address, the forwarding RAM pointer of the matched prefix of the maintree is output (S810). In this case, the address lookup procedure early ends. If the prefix of the address does not match with all the prefixes of the maintree, a default forwarding RAM pointer is output (S818).

In addition, according to the preferred embodiments of the present invention, in a computer-readable recording medium recorded is a program implementing the aforementioned functions of: searching enclosure prefixes in a prefix list for IP address lookup; generating a maintree list by removing the enclosure prefixes from the prefix list and generating an enclosure prefix set including the enclosure prefixes; generating sub-tree lists corresponding to the enclosure prefixes included in the enclosure prefix set; sorting prefixes included in the maintree list and the sub-tree lists in accordance with values of the prefixes; and generating a maintree and sub-trees having the prefixes included in the maintree list and the sub-tree lists as entries, respectively.

Now, the performance of an IP address lookup procedure and a hardware architecture thereof according to the preferred embodiments of the present invention will be described.

The performance of the hardware architecture according to the preferred embodiments of the present invention implemented with C and Verilog languages is tested by using real data of a MAE-WEST router. As described above, a conventional BPT is a huge tree structure having the height of 32. This results from the unbalance of the tree structure, that is, a problem of the conventional BPT. Since the pipelining number is excessive, it is very difficult to implement the conventional BPT.

Firstly, in order to evaluate the performance of the hardware architecture according to the preferred embodiments of the present invention, the MAE-WEST data structure is analyzed. The prefix distribution of the MAE-WEST router is listed in Table 2.

TABLE 2

| | | |
|---|---|---|
| Number of | Number of | Total |
| enclosure | Disjoint | prefix |
| prefix | prefix | count |

| | | | | | |
|---|---|---|---|---|---|
| 1st Level | 1,599 | (5.40%) | 19,001 | (64.23%) | 20,600 |
| Tree | | | | | |
| 2nd Level | 312 | (1.05%) | 7,538 | (25.48%) | 7,850 |
| Tree | | | | | |
| 3rd Level | 50 | (0.17%) | 941 | (3.18%) | 991 |
| Tree | | | | | |
| 4th Level | 1 | (0.01%) | 140 | (0.47%) | 141 |
| Tree | | | | | |
| 5th Level | | | | | |
| Tree | 0 | (0%) | 2 | (0.01%) | 2 |
| Total | 1,962 | (6.63%) | 27,622 | (93.37%) | 29,584 |

As shown in Table 2, the MAE-WEST data structure has a maximum of 5 levels of sub-trees. The number of disjoint prefixes included in the maintree is 19,001, that is, 64.23% of a total number of 29,584 prefixes. The 19,001 prefixes included in the maintree constitute a tree structure having a height of 15, so that a pipelined architecture having 15 stages can be implemented.

In the hardware architecture according to the first preferred embodiment of the present invention, the number of entries of the CAM is 1,962, which is the total number of enclosures. On the other hand, in the hardware architecture according to the second preferred embodiment of the present invention, the number of entries of the CAM is 1,599, which is the number of enclosures in the first level. In addition, according to the simulation, the maximum heights of the sub-trees in the first and second preferred embodiments are 9 and 12, respectively. It can be understood that the maximum heights of the sub-trees in the bot preferred embodiments are within the height of the maintree, that is, 15. Therefore, in the preferred embodiments of the present invention, if the number of the disjoint prefixes included in the maintree is calculated, since the maintree is balanced, a total number of pipelining stages can be calculated.

In the hardware architecture according to the preferred embodiments of the present invention, 5 bits are used to represent prefix length; 32 bits are used to store prefixes; two 14-bit pointers are used to indicate children (since a tree having a maximum of 214 nodes is formed); and 5 bits are used to store a forwarding RAM pointer. Therefore, each node of the tree requires 70 bits. However, a leaf of maintree does not require the two pointers indicating the children. In addition, in the hardware architecture according to the second preferred embodiment of the present invention, in a case where a new sub-tree occurs at the current node, a pointer may be inserted if necessary.

The memory size required for the preferred embodiments of the present invention will be described roughly based on the maintree. In the hardware architecture according to the first preferred embodiment of the present invention, the numbers of internal nodes and leaf nodes out of 19,001 nodes of the maintree are 16,383(2¹⁴-1) and 2,618, respectively, and all the nodes of the sub-tree are the internal nodes, the required memory size is about 240 KB.

Table 3 is a comparison table of the number of memory accesses and the required memory size in conventional architectures and the hardware architecture of the preferred embodiments of the present invention.

[Table 3]

| | Number of | | |
|---|---|---|---|
| | Memory | | |
| Address | Accesses | | |
| Lookup | (Minimum/Maxi- | | |
| Scheme | mum) | Forwarding Table Size | |
| Huang's | 1/3 | 450 KB˜470 | KB |
| scheme | | | |
| DIR-24-8 | 1/2 | 33 | MB |
| DIR-21-3-8 | 1/3 | 9 | MB |
| Parallel | 1/5 | 189 | KB |
| Hashing | | | |
| Proposed | 1/1 | 2000-entry CAM, 240 | KB |
| Architecture | | | SRAM |

It can be understood that the hardware architecture according to the preferred embodiments of the present invention is very excellent in terms of the number of memory accesses and the required memory size. In addition, in the hardware architecture according to the preferred embodiments of the present invention since all the pipeline stages have the same structure, it is easy to design VLSI (Very Large Scale Integrated) circuits.

(Third Embodiment)

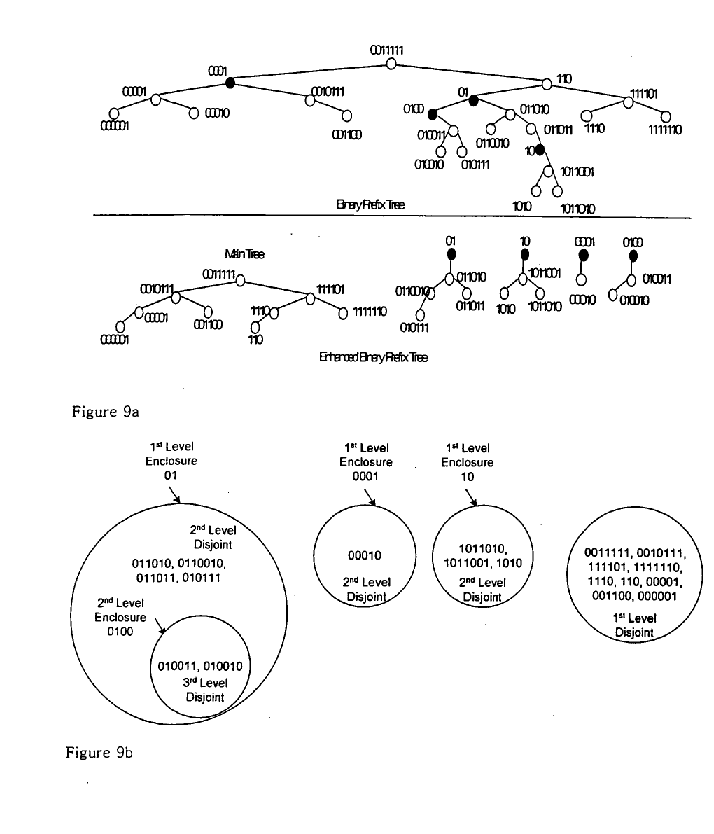

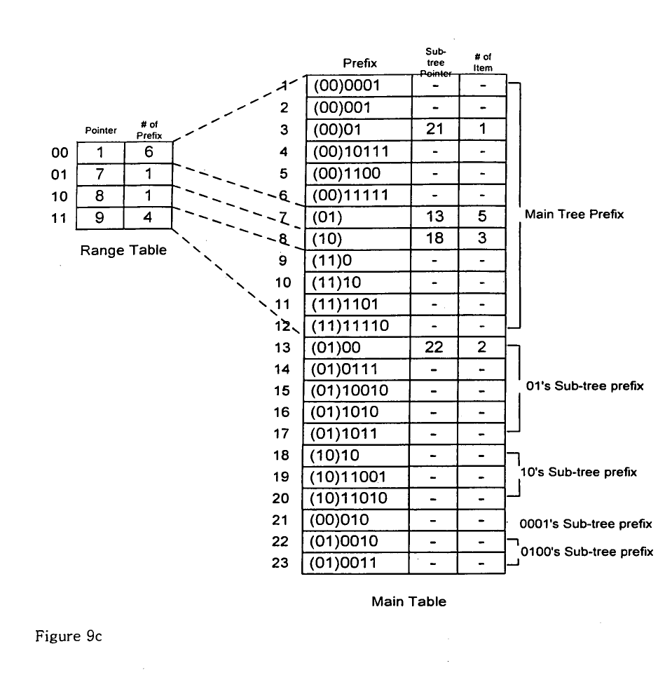

FIG. 9 is a view showing a hardware architecture implementing an EnBiT according to a third preferred embodiment of the present invention.

In FIG. 9a, there are shown a convention BPT and an EnBiT (enhanced binary tree) according to the third preferred embodiment of the present invention. In the conventional BPT, general enclosures and sub prefixes of the enclosures constitutes an unbalanced tree structure. In the EnBiT, there are multiple balanced tree structures. Therefore, the EnBiT has advantages in that the address lookup procedure can be completed by one memory access. However, the EnBiT has disadvantages in that the SRAM size for each tree depth is determined based on the prefix distribution characteristics of the routing table.

In the third preferred embodiment of the present invention, attention is paid to the fact that, if balanced trees are formed with disjoint prefixes, a perfect binary search process can be performed. In the embodiment, multiple balanced trees are stored in a single memory and the binary search process is sequentially performed on the trees. The binary search process is performed on nodes of the balanced trees by using memory indices without storing the pointers indicating the children of the nodes, so that memory efficiency can remarkably increase. As a result, the required memory size is small enough to be used for a cash memory and the memory size for the routing table is determined based on not the prefix length but the number of prefixes. Therefore, the EnBiT structure can be easily adapted to the IPv6. Search times has an O(logₖN) performance, where N is the number of prefixes and k of the binary search process is 2. If a search range is reduced by using a range table, the search times can be further reduced. Since it is a flexible structure, the EnBiT structure according to the third preferred embodiment can be processed by a general processor in a software manner.

FIG. 9b is a view showing a prefix classifying method according to the third embodiment of the present invention.

In FIG. 9b, the prefixes shown in FIG. 9b are classified. As a result of the classification, prefix information such as levels and types of the prefixes can be obtained. If a prefix is included in a sub-tree of an enclosure, the level of the prefix rises. For example, in FIG. 9b, the prefixes 01*, 0100*, and 010011* are the first, second, and third level enclosures, respectively. The first level enclosure prefixes and the first level disjoint prefixes constitute the maintree. The second level enclosure prefixes and the second level disjoint prefixes constitute a sub-tree of the first level enclosure.

FIG. 9c is a view showing a prefix storing method according to the third embodiment of the present invention.

The classified prefixes shown in FIG. 9b are stored in the main table shown in FIG. 9c. Out of the prefixes, the first level enclosure prefixes and disjoint prefixes are stored in the first section of the main table in the order of values, so that the binary search process can be performed. The enclosure prefixes stored in the main table have information on the pointers indicating the associated sub-trees and the number of prefixes included in sub-trees. The sub-trees of the enclosure are also stored in the memory in the order of values. If there is an enclosure prefix among the sub prefixes, the enclosure prefix also has information on the pointers indicating the associated sub-trees and the number of prefixes included in sub-trees. The disjoint prefix does not have the information on the sub-tree. The range table shown in FIG. 9c includes information on the first-two bits of the prefixes stored in the main table. Each entry of the range table indicates the number and the position of the prefixes corresponding to the memory index of the range table. Since the first-two bits are used for the memory index of the range table, it is unnecessary to store the first-two bits in the main table. Therefore, the remaining bits of the prefix are stored in the main table. The first-two bits are represented by using parentheses in FIG. 9c.

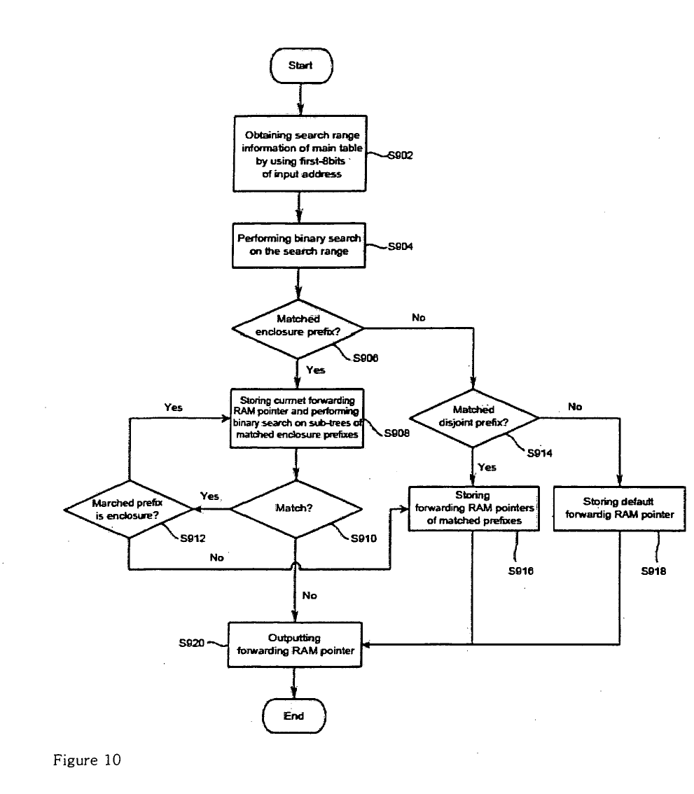

FIG. 10 is a flowchart showing the IP address lookup procedure according to the third preferred embodiment of the present invention.

For example, in order to perform a 32-bit IP address lookup procedure, the architecture according to the present invention uses a range table having 8-bit indices, where 8-bit is the shortest prefix length of the IPv4 prefixes. The address lookup procedure starts with the range table. Search range information of the main table is obtained from the range table by using the first-8 bits of the destination IP address of the input packet as the indexes of the range table. Next, a first level binary search process is performed on the first level enclosure prefixes and the disjoint prefixes within the search range in order to retrieve a matched prefix. If a matched disjoint prefix is retrieved, the forwarding RAM pointer of the associated entry is output and then the address lookup procedure ends. If a matched enclosure prefix is retrieved, the forwarding, RAM pointer of the enclosure prefix is stored and then the address lookup procedure proceeds to the sub-tree of the enclosure. If there is a matched entry in the sub-tree of the enclosure, the value of the forwarding RAM pointer is output.

Now, the IP address lookup procedure of the present invention applied to one or more pipeline binary trees will be described. Here, the pipeline binary tree is constructed by using a main table where prefixes divided based on levels thereof are classified into maintree prefixes and sub-tree prefixes and a range table where information on the maintree prefixes is included.

Firstly, search range information of the main table is obtained from the range table by using the first few bits of the input address (S902). A binary search process is performed on the first level enclosure prefixes and the disjoint prefixes in the main table corresponding to the search range information (S904). Next, it is determined whether or not the enclosure prefixes match with the input address (S906).

As a result of the step S906, if the enclosure prefix matching with the prefix of the input address is retrieved, the forwarding RAM pointer of the matched enclosure prefix is stored, and the binary search process proceeds to the sub-tree of the matched enclosure prefix (S908). Next, the prefixes of the sub-trees having the matched enclosure prefix as root node are compared with the input address (S910).

As a result of the step S910, if the newly matched prefix is retrieved in the sub-tree and the retrieved matched prefix is enclosure prefix (S912), the forwarding RAM pointer of the enclosure prefix is stored. Until the retrieved matched prefix is not enclosure prefix or until there is not the newly matched prefix, the above process is repeatedly performed.

As a result of the step S910, if the newly matched prefix is retrieved in the sub-tree and if the retrieved matched prefix is not enclosure prefix (S912), the forwarding RAM pointer of the last retrieved matched enclosure prefix is stored and output (S916 and S920).

As a result of the step S910, if the newly matched prefix is not retrieved in the sub-tree, the forwarding RAM pointer of the last retrieved prefix is output (S920).

As a result of the step S906, if the disjoint prefix matching with the input address is retrieved (S914), the forwarding RAM pointer of the retrieved prefix is output (S916 and S920).

As a result of the step S906, if the disjoint prefix matching with the input address is not retrieved, a default forwarding RAM pointer is output (S918 and S920).

These comparison steps are performed by using the binary search process. All the nodes of one or more binary trees are stored in a single memory.

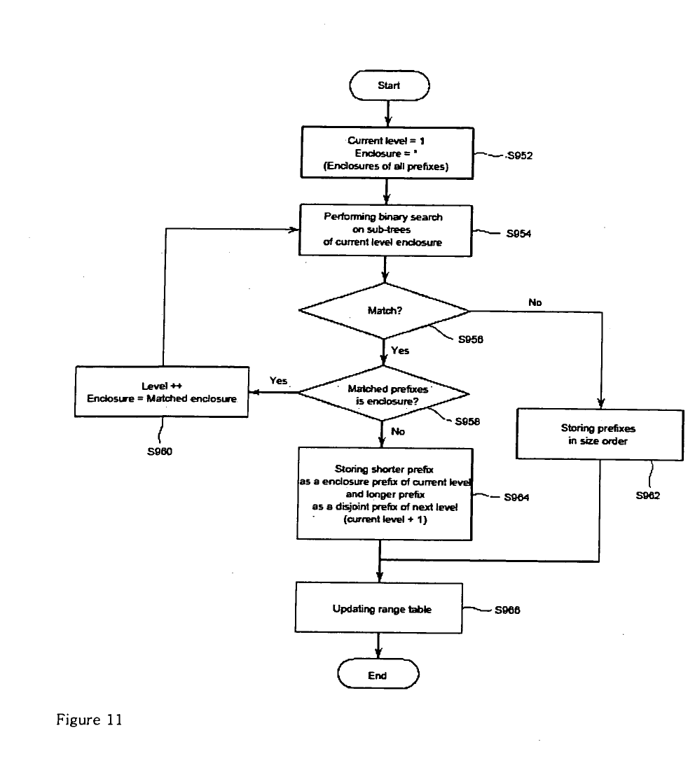

FIG. 11 is a flowchart showing a process of inserting prefixes to the EnBiT structure according to the third preferred embodiment of the present invention.

In the architecture according to the present invention, it is assumed that a certain ratio of entries between the sub-trees are empty for the purpose of updating. In addition first-8 bits of the prefix are not stored in the main table and the range table information is updated at the same time of storing in the main table. For example, in a case where the prefix 0010* intends to be inserted, firstly a range of the prefixes starting with “00” is retrieved by using the range table. Since the prefix 0010* is disjoint to the first level enclosures and the disjoint prefixes within the range, the prefix 0010* is stored in the order of values thereof. In addition, since the prefix starting with “00” is stored, the corresponding range table information is updated. In a case where the prefix 100* intends to be inserted, the prefix 100* is the sub-prefix of the prefix 10*, the prefix 100* is moved to the sub-tree of the prefix 10*. Since the sub-prefix of the prefix 10* and the prefix 100* are disjoint to each other, the prefix 100* is stored in the sub-tree in the order of values thereof, and the information on the main table is updated. In a case where the prefix 1100* intends to be inserted, the prefix 1100* are sub-prefix of the prefix 110* which is the first level disjoint prefix, the prefix 110* is an enclosure and the prefix 1100* is stored in the sub-tree. In a case where the prefix 1111* intends to be inserted, the prefix 1111* is an enclosure having the first level disjoint prefixes 111101* and 1111110* as sub-prefixes, the prefix 1111* is stored as the first level enclosure, and the prefixes 111101* and 1111110* are stored as the second level disjoint prefixes.

More specifically, the current level is set to “1” and the to-be-inserted prefix, all the prefixes of the first level of the main table, and the sub-trees of the first level enclosure prefixes are searched (S952 and S954). It is determined whether or not there are prefixes matching with the to-be-inserted prefix (S956).

As a result of the step S986, if the matched prefix is retrieved, it is determined whether or not the matched prefix is enclosure prefix (S958).

As a result of the step S958, if the matched prefix is enclosure prefix, the level increases by “1”, the sub-tree of the enclosure prefix of the next level is searched to determine whether or not there are prefixes matching with the to-be-inserted prefix and whether or not the matched prefix is enclosure prefix. The search process is repeatedly performed until there is not prefix matching with the to-be-inserted prefix or until the matched prefix is not enclosure prefix (S960).

As a result of the step S956, if there is not the matched prefix, the to-be-inserted prefix is inserted to the prefix of the current level. And then, the prefix is sorted in the order of values thereof and stored (S962).

As a result of the step S958, if the matched prefix is not enclosure of other prefixes, the matched prefix is compared with the to-be-inserted prefix. Then, a prefix having a shorter length than the to-be-inserted prefix is stored as an enclosure prefix of the current level and a prefix having a longer length than the to-be-inserted prefix is stored as a disjoint prefix of the next level increasing by “1” from the current level (S964). Since the prefix is inserted to the main table, the range table is updated.

According to the present invention, it is possible to efficiently utilize a memory by using the best advantage of a binary prefix tree structure in that there is no empty node in the tree and the fact that a binary search process can be implemented by using pipelines. In addition, it is possible to provide a practical, excellent architecture capable of performing an address lookup procedure by using at most one content addressable memory access and one memory access.

According to the present invention, an EnBiT has excellent performance in table updating. In addition, the EnBiT can be easily scaled into the IPv6. In addition, as a simulation using an actual prefix distribution obtained from the MAE-WEST having about 30,000 routers prefixes, a total of 15 stages are generate and a content addressable memory having about 2000 entries and 15 memories are used, so that the required memory size is 250 Kbytes of memory. Therefore, it is possible to implement a very excellent address lookup procedure and hardware architecture.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An IP address lookup method using at least one pipeline binary tree having enclosure prefixes as root nodes, comprising steps of:
(a) comparing an input address with the enclosure prefixes;
(b) as a result of the step (a), if the enclosure prefixes matching with the input address are retrieved, temporarily storing a forwarding RAM pointer of a longest matched enclosure prefix, wherein the longest matched enclosure prefix is an enclosure prefix longest matching with the input address in terms of bits among the matched enclosure prefixes;
(c) comparing the input address with prefixes of a sub-tree having the longest matched enclosure prefix as a root node;
(d) as a result of the step (c), if there is the prefix of the sub-tree newly matching with the input address, outputting forwarding RAM pointer of the newly matched prefix of the sub-tree;
(e) as a result of the step (c), if the prefix of the sub-tree newly matching with the input address is not retrieved, outputting the forwarding RAM pointer temporarily stored in the step (b);
(f) as a result of the step (a), if the enclosure prefixes matching with the input address are not retrieved, comparing maintree prefixes with the input address;
(g) as a result of the step (f), if the maintree prefix matching with the input address is retrieved, outputting forwarding RAM pointer of the matched maintree prefix; and
(h) as a result of the step (f), if the maintree prefix matching with the input address is not retrieved, outputting a default forwarding RAM pointer.

2. The IP address lookup method according to claim 1, wherein the comparison in the steps (c) and (f) is performed by using a binary search scheme.

3. The IP address lookup method according to claim 1, wherein the maintree and the sub-tree are constituted with only disjoint prefixes.

4. The IP address lookup method according to claim 1, wherein nodes included in each depth of the pipeline binary tree are stored in one memory.

5. The IP address lookup method according to claim 1, wherein memory access in each depth is performed by using a pipelining scheme.

6. The IP address lookup method according to claim 1, wherein the root nodes are stored in a content addressable memory (CAM).

7. The IP address lookup method according to claim 1, wherein each of entries of the root nodes stores information on the prefix, a forwarding RAM pointer, and a pointer to a sub-tree.

8. The IP address lookup method according to claim 1, wherein each of entries of nodes other than the root node stores information on the prefix, a forwarding RAM pointer, and pointers to child nodes of the node.

9. An IP address lookup method using at least one pipeline binary tree having only first-level enclosure prefixes as root nodes, comprising steps of:
(a) comparing an input address with the enclosure prefixes;
(b) as a result of the step (a), if the enclosure prefix matching with the input address is retrieved, temporarily storing forwarding RAM pointer of the matched enclosure prefix;
(c) comparing prefixes of a sub-tree having the enclosure prefix as root node with the input address;
(d) as a result of the step (c), if there is the prefix of the sub-tree newly matching with the input address and the newly matched prefix of the sub-tree has sub-tree pointer, repeatedly comparing the sub-tree prefixes indicated by the sub-tree pointers with the input address until a sub-tree prefix not having the sub-tree pointer is searched;
(e) as a result of the step (d), if there is the prefix of the sub-tree newly matching with the input address and the newly matched prefix of the sub-tree does not have sub-tree pointer or if the prefix of the sub-tree newly matching with the input address is not retrieved, outputting a forwarding RAM pointer of a sub-tree prefix last retrieved in the step (d);
(f) as a result of the step (c) if the prefix of the sub-tree newly matching with the input address is not retrieved, outputting the forwarding RAM pointer temporarily stored in the step (b);
(g) as a result of the step (a), if the enclosure prefix matching with the input address is not retrieved, comparing maintree prefixes with the input address;
(h) as a result of the step (g), if the maintree prefix matching with the input address is retrieved, outputting forwarding RAM pointer of the matched maintree prefix; and
(h) as a result of the step (f), if the maintree prefix matching with the input address is not retrieved, outputting a default forwarding RAM pointer.

10. The IP address lookup method according to claim 9, wherein the comparison in the steps (c), (f) and (g) is performed by using a binary search scheme.

11. The IP address lookup method according to claim 9, wherein the maintree and the sub-tree are constituted with only disjoint prefixes.

12. The IP address lookup method according to claim 9, wherein nodes included in each depth of the pipeline binary tree are stored in one memory.

13. The IP address lookup method according to claim 9, wherein the root nodes are stored in a content addressable memory (CAM).

14. An IP address lookup hardware architecture using at least one pipeline binary tree having enclosure prefixes as root nodes, comprising:
a content addressable memory (CAM) storing enclosure prefixes;
a memory storing nodes other than the root nodes; and
a processing unit for constructing a maintree and a sub-tree by treating the enclosure prefixes as root nodes and performing an address lookup procedure by comparing an input address with prefixes included in the nodes of the maintree and the sub-tree.

15. The IP address lookup hardware architecture according to claim 14, wherein the maintree and the sub-tree are constituted with only disjoint prefixes.

16. The IP address lookup hardware architecture according to claim 14, wherein nodes included in each depth of the pipeline binary tree are stored in one memory.

17. The IP address lookup hardware architecture according to claim 14, wherein memory access in each depth is performed by using a pipelining scheme.

18. The IP address lookup hardware architecture according to claim 14, wherein each of entries of the root nodes stores information on the prefix, a forwarding RAM pointer, and a pointer to a sub-tree.

19. The IP address lookup hardware architecture according to claim 14, wherein each of entries of nodes other than the root node stores information on the prefix, a forwarding RAM pointer, and pointer to child nodes of the node.

20. The IP address lookup hardware architecture according to claim 14, wherein the content addressable memory stores root nodes of a sub-tree having first-level enclosure prefixes as root entries among the root nodes of the sub-trees.

21. A computer-readable recording medium recording a program used for a system for generating a pipeline binary tree for IP address lookup, wherein the program implementing the functions of:
(a) searching enclosure prefixes in a prefix list for IP address lookup;
(b) generating a maintree list by removing the enclosure prefixes from the prefix list and generating an enclosure prefix set including the enclosure prefixes;
(c) generating sub-tree lists corresponding to the enclosure prefixes included in the enclosure prefix set;
(d) sorting prefixes included in the maintree list and the sub-tree lists in accordance with values of the prefixes;
(e) generating a maintree and sub-trees having the prefixes included in the maintree list and the sub-tree lists as entries, respectively; and
(f) inserting, removing, and updating entries to the pipeline binary tree.

22. The computer-readable recording medium according to claim 21, wherein the generation of the maintree list and the sub-tree lists and the arrangement of the prefixes are performed by using a recursive subroutine.

23. The computer-readable recording medium according to claim 21, wherein the maintree and the sub-tree are constituted with only disjoint prefixes.

24. The computer-readable recording medium according to claim 21, wherein nodes included in each depth of the pipeline binary tree are stored in one memory.

25. The computer-readable recording medium according to claim 21, wherein the root nodes of the sub-trees are stored in a content addressable memory (CAM).

26. The computer-readable recording medium according to claim 21, wherein memory access in each depth is performed by using a pipelining scheme.

27. The computer-readable recording medium according to claim 21, wherein each of entries of the root nodes stores information on the prefix, a forwarding RAM pointer, and a pointer to a sub-tree.

28. The computer-readable recording medium according to claim 21, wherein each of entries of nodes other than the root node stores information on the prefix, a forwarding RAM pointer, and a pointer to a child node of the node.

29. The computer-readable recording medium according to claim 21, wherein the root nodes of a sub-tree having first-level enclosure prefixes as root entries among the root nodes of the sub-trees are included in a content addressable memory (CAM).

30. The computer-readable recording medium according to claim 21, wherein, in the step of inserting the entries to the pipeline binary tree, if a prefix having a to-be-inserted prefix as an enclosure is retrieved and if the retrieved prefix is not an enclosure prefix, a sub-tree of the to-be-inserted prefix is constructed with only the retrieved prefix and the entry of the retrieved prefix is removed.

31. The computer-readable recording medium according to claim 21, wherein, in the step of inserting the entries to the pipeline binary tree, if a prefix having a to-be-inserted prefix as an enclosure is retrieved, the to-be-inserted prefix and a forwarding RAM pointer of the to-be-inserted prefix are inserted to an enclosure set.

32. The computer-readable recording medium according to claim 21, wherein in the step of inserting the entries to the pipeline binary tree, if a to-be-inserted prefix is disjoint to the other prefixes, the to-be-inserted prefix is inserted as a new leaf of the main tree.

33. The computer-readable recording medium according to claim 21, wherein, in the step of removing entries from the pipeline binary tree, if a to-be-removed prefix is retrieved, a forwarding RAM pointer of the to-be-removed is represented to be invalid.

34. A method of inserting entries to a pipeline binary tree used for an IP address lookup procedure, comprising steps of:
(a) determining whether or not there is a prefix matching with a to-be-inserted prefix;
(b) as a result of the step (a), if a matched prefix is retrieved, determining whether or not the to-be-inserted prefix is an enclosure of other enclosure prefixes;
(c) as a result of the step (b), if the to-be-inserted prefix is an enclosure of other enclosure prefixes, inserting the to-be-inserted prefix and the forwarding RAM pointer of the to-be-inserted prefix to an enclosure set;
(d) as a result of the step (b), if the to-be-inserted prefix is not an enclosure of the other enclosure prefixes, determining whether or not the to-be-inserted prefix is an enclosure of other prefix;
(e) as a result of the step (d), if the to-be-inserted prefix is an enclosure of other prefix, constructing a sub-tree of the to-be-inserted prefix with only the retrieved prefix, removing the entry of the retrieved prefix, and inserting the to-be-inserted prefix to the enclosure set;
(f) as a result of the step (d), if the to-be-inserted prefix is not an enclosure of other prefix, inserting the retrieved prefix to the enclosure set, removing the retrieved prefix from a tree where the retrieved prefix is included, and constructing a sub-tree of the retrieved prefix with the to-be-inserted prefix; and
(g) as a result of the step (a), if a matched prefix is not retrieved, inserting the to-be-inserted prefix as a new leaf node to the main tree.

35. The method according to claim 34, wherein, in the step of removing entries, if a to-be-removed prefix is retrieved, a forwarding RAM pointer of the to-be-removed is represented to be invalid.

36. An IP address lookup method using at least one pipeline binary tree, the pipeline binary tree being constructed by using a main table where prefixes divided based on levels thereof are classified into maintree prefixes and sub-tree prefixes and a range table where information on the maintree prefixes is included, the IP address lookup method comprising steps of:
(a) obtaining search range information of the main table from the range table by using the first few bits of the input address;
(b) comparing the input address with first level enclosure prefixes and the disjoint prefixes in the main table corresponding to the search range information by using a binary search process;
(c) as a result of the step (b), if the enclosure prefix matching with the input address is retrieved, storing a forwarding RAM pointer of the retrieved enclosure prefix;
(d) comparing the input address with prefixes of sub-trees having the matched enclosure prefix as root node;
(e) as a result of the step (d), if the newly matched prefix is retrieved in the sub-tree and the retrieved matched prefix is enclosure prefix, storing the forwarding RAM pointer of the enclosure prefix; and repeatedly performing the above steps until the retrieved matched prefix is not enclosure prefix or until there is not the newly matched prefix;
(f) as a result of the step (d) or (e), if the newly matched prefix is retrieved in the sub-tree and if the retrieved matched prefix is not enclosure prefix, storing and outputting the forwarding RAM pointer of the last retrieved matched prefix;
(g) as a result of the step (d) or (e), if the newly matched prefix is not retrieved in the sub-tree, outputting the forwarding RAM pointer of the last retrieved prefix;
(h) as a result of the step (b), if the disjoint prefix matching with the input address is retrieved, storing and outputting the forwarding RAM pointer of the matched disjoint prefix; and
(i) as a result of the step (b), if the disjoint prefix matching with the input address is not retrieved, storing and outputting a default forwarding RAM pointer.

37. The method according to claim 36, wherein comparison processes in the steps (b), (d), and (e) are performed by using the binary search process.

38. The method according to claim 36, wherein all the nodes of each level of one or more binary trees are stored in a single memory.

39. A method of inserting entries to a pipeline binary tree, the pipeline binary tree being constructed by using a main table where prefixes divided based on levels thereof are classified into maintree prefixes and sub-tree prefixes and a range table where information on the maintree prefixes is included, the method comprising steps of:
(a) determining whether or not there is a prefix matching with a to-be-inserted prefix among all the prefixes of the first level of the main table and the sub-trees of the first level enclosure prefixes;
(b) as a result of the step (a), if the matched prefix is retrieved, determining whether or not the matched prefix is enclosure prefix;
(c) as a result of the step (b), if the matched prefix is enclosure prefix, increasing the level by one, performing a search process on the sub-trees of the enclosure prefix of the next level to determine whether or not there is prefix matching with the to-be-inserted prefix and whether or not the matched prefix is enclosure prefix; and repeatedly performing the search process until there is not prefix matching with the to-be-inserted prefix or until the matched prefix is not enclosure prefix.
(d) as a result of the step (a) or (c), if there are not the matched prefixes, inserting the to-be-inserted prefix as a prefix of the current level, and sorting and storing the prefix in the order of values thereof;
(e) as a result of the step (b) or (c), if the matched prefix is not enclosure of other prefixes, comparing the matched prefix with the to-be-inserted prefix; storing prefix having a shorter length than the to-be-inserted prefix as an enclosure prefix of the current level; and storing prefix having a longer length than the to-be-inserted prefix as a disjoint prefix of the next level increasing by one from the current level; and
(f) updating the range table in accordance with change of the main table by inserting the prefix thereto.
